(19) United States
(12) Patent Application Publication
(10) Pub. No.: US 2008/0142137 A1
(43) Pub. Date: Jun. 19, 2008

(54) Patch for Repairing Tires by Vulcanization

(76) Inventor: Patric Scheungraber, Pliening (DE)

Correspondence Address: FROST BROWN TODD, LLC, 2200 PNC CENTER, 201 E. FIFTH STREET, CINCINNATI, OH, 45202, US

(21) Appl. No.: 11/885,729

(22) PCT Filed: Mar. 7, 2006
(86) PCT No.: PCT/EP06/02100

§ 371 Date: Sep. 5, 2007

(30) Foreign Application Priority Data
Mar. 8, 2005 (DE) 20 2005 003 662.5

(51) Int. Cl. B29C 73/06; B29C 73/10; B32B 33/00

(52) U.S. Cl. 152/370; 152/367; 428/41.7

(57) ABSTRACT

The invention relates to a patch for repairing tires, hoses and the like by vulcanization comprising at least one cover layer (1) made of a vulcanized rubber material, a joining layer (3) which is made of a rubber material and is laterally projected with respect to said cover layer (1) in an edge area (4), a protective film covering the top surface of the joining layer (3) and a thin flexible peel-off film (7) which loosely covers the surface of the cover layer (1) and adheres to the projected edge (4) of the joining layer (3), wherein said peel-off film (7) which covers the cover layer (1) and the projected edge (4) of the joining layer (3) is provided with a gripping element (8) for the removal thereof.

### BACKGROUND OF THE INVENTION

The invention relates to a patch for repairing tires by vulcanization comprising at least one cover layer made of a vulcanized rubber material and optionally reinforced by inserts, a thinner joining layer made of a non-vulcanized vulcanizable rubber material and laterally projected with respect to the cover layer in an edge area, a stable protective film detachably arranged on the outer surface of the joining layer and a peel-off film which covers the top surface of the cover layer and adheres to the projected edge of the joining layer.

Such patches or adhesive tape have been known for a long time in multiple different embodiments and are used for repairing vehicle tires and hoses. Even after long storage times the joining layer which is made of an unvulcanized vulcanized rubber material and is of decisive importance for a gastight permanent adhesion of the patch must be fully functional. In order to prevent undesired vulcanization phenomena of this joining layer during storage time, the joining layer is completely covered by a rigid adhesive protective layer which, among others, is impervious to gas and light. This protective film is removed manually immediately before the use of such adhesive tape. To facilitate this peel-off process, in particular the gripping of a portion of the film, this semirigid protective film includes a rupture seam. Additionally, the top surface of the cover layer made of vulcanized rubber material is covered by a protective film which is substantially thinner and more flexible than the protective film of the joining layer and may be a transparent expanded thermoplastic film. As the fully vulcanized cover layer has no adhesive strength, it is spanned by the thin protective layer without it adhering thereto, a continuous adhesion of the protective film being present only on the projected edge area of the joining layer on rubber material which is not yet vulcanized. The thin protective layer will also have to be peeled off in the course of the actual repair process which sometimes causes trouble and requires the use of a tool.

It is the objective of the invention to facilitate the peel-off process of the thin protective film covering the cover layer.

According to the invention this object is solved by the fact that the protective film covering the cover layer and the projected edge of the joining layer includes a gripping element for peeling off the protective film. Advantageously, the gripping element consists of a fold of the protective film provided in the central area of the patch, which may be gripped by two fingers of the hand.

### SUMMARY OF THE INVENTION

The invention is suitable for application on various patches and adhesive tapes for repairing hoses, tires, conveyor belts and other rubber articles. The inventive design of the thin protective film which comprises at least one gripping fold leads to rendering the manufacturing processes simpler and effective in a cost-neutral manner. The removal of the thin protective layer during the performance of the repair, particularly after the stitching of the repair body, will be optimized without the film coming off on its own during the storage or the transport of the patch. No additional tools are required for peeling off the film. The gripping fold preferably provided in the central area ensures a complete and tear-free peeling-off of the protective layer, all but in one go, without any film remnants remaining on the cover layer and the projected adhesive edge of the joining layer, respectively.

### BRIEF DESCRIPTION OF THE DRAWINGS

Next, embodiments of the inventive patch will be described in detail with reference to the drawing, wherein:

FIG. 1 shows an enlarged cross-section of an adhesive tape for repairing tires;

FIG. 2 shows an enlarged cross-section of an adhesive repair tape comprising a filler mandrel suitable for repairing stab damage to a pneumatic.

### DETAILED DESCRIPTION OF THE INVENTION

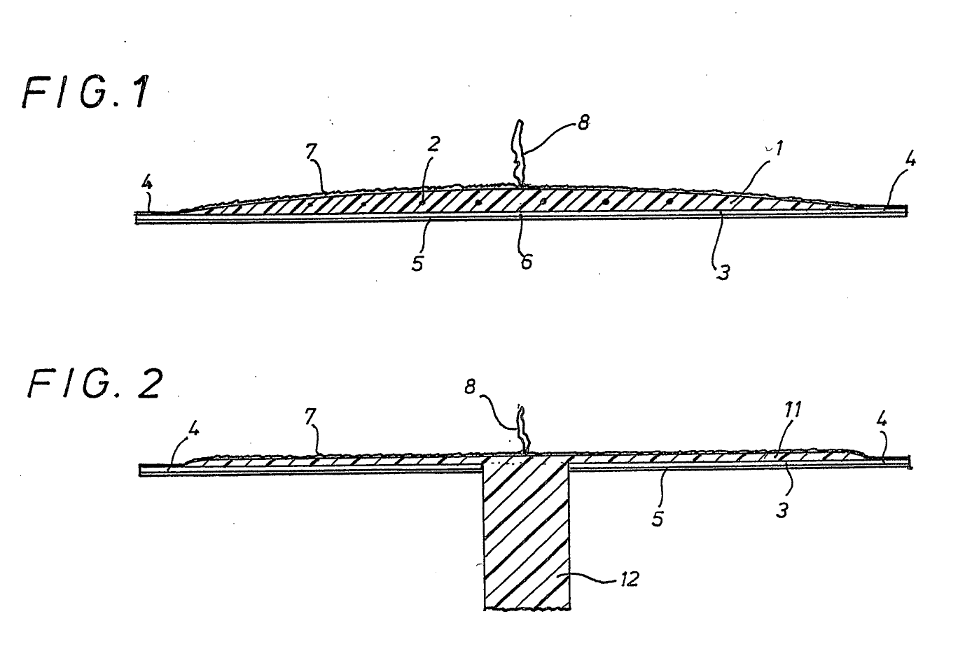

The adhesive repair tape shown in a cross-section in FIG. 1 has a cover layer 1 gradually thickening towards the center, which is optionally reinforced in its central area by an insert 2 consisting herein of a parallel plastic or textile filaments or a suitable metal as well as combinations of these materials. The insert may also have a mesh-like or fabric-like structure. The cover layer 1 consists of a fully vulcanized rubber material and may have a configuration of a plurality of layers solidly connected by vulcanization. As a whole or in certain layers the cover layer 1 may consist of an unvulcanized vulcanizable rubber material which will fully vulcanize only in the course of or after the performance of the repair. A joining layer 3 consisting of an unvulcanized vulcanizable rubber material and being projected on all sides with respect to the circumferential edge of the cover layer 1 adheres throughout to the bottom surface of the cover layer 1. The outer surface of the joining layer 3 is covered by a continuously adhering protective film 5 wherein a preformed rupture line 6 is formed. The protective film 5 consists of a preferably colorful gastight thermoplastic and prevents accidental vulcanization processes of the joining layer 3 to maintain the functionality thereof even after long storage times. The top surface of the cover layer 1 is covered by a thin protective film 7 loosely lying on the top surface of the cover layer 1 and adhering to the whole circumferential edge 4 of the joining layer 3. In this embodiment the extremely thin and correspondingly flexible film 7 consists of a transparent thermoplastic material. If the cover layer 1 consists of a rubber material which is unvulcanized and vulcanizable up to the time the repair is performed, the protective film 7 should have characteristics similar to the protective film 5 associated with the joining layer 3 so that premature vulcanization processes, for example during storage, will be prevented in the cover layer 1.

In order to facilitate the peeling-off of the film before the illustrated patch is used the film 7 has a gripping fold 8 which in the present embodiment is arranged in the central area of the patch and may extend throughout to the opposite edge areas 4 of the joining layer. During storage of the patches the gripping fold 8 is turned down due to the flexibility of the film 7 and extends approximately in parallel to the adjoining film areas. To pull off the film 7, the gripping fold is brought approximately into the position as shown and by pulling at the gripping fold with one's fingers the protective film 7 can be peeled off without any tear forming, the adhesion, which exists only in the edge area, being detached together with the adhesive joining layer.

The patch shown in FIG. 2 substantially corresponds to the patch according to FIG. 1. The only difference is the design of the cover layer 11 which herein has a uniform thickness throughout and is integrally formed with a central mandrel 12. The other individual parts correspond to the components of FIG. 1 and are designated by the same reference numerals. The cover layer 11 may also have a thickness decreasing from the center to the outside corresponding to the cover layer 1 of FIG. 1, and together with the shaft-like mandrel 12 it may consist of an already vulcanized or unvulcanized vulcanizable rubber material.

It is an essential advantage of the patch according to the invention that the peeling-off of the protective film 7 is substantially facilitated without the manufacturing costs for such patch being noticeably increased thereby. The shape of the protective layer still corresponds to the outline of the joining layer so that the outer edge of the protective film coincides with the protected adhesive outer edge of the joining layer. Only the size of the protective layer must be selected to be slightly larger than that of the joining layer so that due to its adhesion in the region of the circumferential edge the gripping fold appears by itself.

The invention is not limited to the embodiments as shown. Rather, the protective layer formed according to the invention may also be used for other rubber articles having an edge made an unvulcanized and thus adhesive material.

1-7. (canceled)

8. A patch for repairing tires, hoses and the like by vulcanization comprising
at least one cover layer made of a vulcanized rubber material,
a joining layer which is made of a rubber material and is laterally projected with respect to said cover layer in an edge area,
a protective film covering the top surface of the joining layer, and
a thin flexible peel-off film which loosely covers the surface of the cover layer and adheres to the projected edge of the joining layer;
wherein said peel-off film which covers the cover layer and the projected edge of the joining layer is provided with a gripping element for the removal thereof.

9. The patch according to claim 1, wherein said cover layer is reinforced by inserts.

10. The patch according to claim 1, wherein said protective film covers the top surface of the joining layer throughout.

11. The patch according to claim 1, wherein said gripping element is a gripping fold of the peel-off film provided in the central area.

12. The patch according to claim 1, wherein a projected repair mandrel is formed on the cover layer.

13. The patch according to claim 1, wherein at the time the repair is performed said cover layer is also made of a still unvulcanized and vulcanizable rubber material.

14. The patch according to claim 1, wherein said joining layer is made of an unvulcanized and vulcanizable rubber material.
